(19) United States
(12) Patent Application Publication
(10) Pub. No.: US 2008/0225807 A1
(43) Pub. Date: Sep. 18, 2008

(54) Transmitter, receiver and system as well as related methods and computer programs for identifying at least one network capability

(75) Inventor: Basavaraj Patil, Coppell, TX (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/723,173

(22) Filed: Mar. 16, 2007

(51) Int. Cl. H04Q 7/24

(52) U.S. Cl. 370/338

(57) ABSTRACT

It is disclosed a method comprising transmitting an identifier for identifying at least one network capability related to mobile internet protocol,

wherein the identifier is configured to indicate capability or incapability of mobile internet protocol support, and a method comprising receiving an identifier for identifying at least one network capability, and retrieving an address from the network based on the identifier.

### FIELD OF THE INVENTION

The present invention relates to a transmitter, receiver and system as well as related methods and computer programs for identifying at least one network capability. In particular, the present invention is advantageously applicable in networks capable of IP (Internet Protocol) such as mobile IP (MIP) or Proxy Mobile IP (PMIP).

### BACKGROUND

Communication technology has made considerable progress in recent time. Concerning especially mobile communication networks, an ever rising demand for accommodating and offering services to users e.g. of so-called moving host entities, i.e. host entities with temporary access to a given access entity in a network, has emerged.

The host entity (entities) of the one or more user(s) may access the network via an access technology, e.g. WiMAX (Worldwide Interoperability for Microwave Access), WLAN (Wireless Local Access Network), xDSL (Digital Subscriber Line), xPON (Passive Optical Network) or a cable modem without being restricted to these access technologies. The access to the network for the host is effected e.g. via an access router or gateway entity which is located in the access network, e.g. as an access server.

Network based mobility in GPRS (General Packet Radio Service) is achieved e.g. via the use of GTP (GPRS tunneling Protocol). Mobile IP as e.g. specified in RFC3344 and RFC3775 is a host entity based mobility solution.

Proxy Mobile IP is an enhancement to host based mobility solutions which have been specified e.g. in RFCs (Request for Comments) 3344 and 3775. To enable mobility for host entities not having an inherent mobility client, Proxy Mobile IP is a feasible solution. With proxy Mobile IP, a proxy agent for the host entity is instantiated in the access network, wherein the proxy agent is responsible for the mobility management of the host entity. The proxy agent manages the mobility using Mobile IP signalling with a home agent.

In other words, PMIP is an IP mobility solution in which the host entity is not involved in the signalling with the home agent, to manage the host entity mobility. Instead, the proxy agent instantiated in the access network (e.g. in the access entity that the host entity is attached to) is configured to perform the Mobile IP signalling with the home agent and manages the mobility for the host entity.

PMIP of such a kind may have one or more of the following drawbacks:

The host entity lacks awareness of network capabilities:

With proxy Mobile IP, a host entity is unaware that a proxy agent has been instantiated in the network which is responsible for the mobility management of the host entity. Therefore, the host entity is unaware of whether or not the access network that the host entity is attaching to supports Proxy Mobile IP.

It is unable to cope with the effects resulting from unawareness of support or lack of support of Proxy Mobile IP:

A host entity equipped with an inherent Mobile IP client may in some cases delay sending the Mobile IP registration or binding update for various reasons. However, a proxy agent gets triggered in the network if the host entity does not initiate Mobile IP signalling. Also if proxy Mobile IP has been instantiated, the host entity may not be able to revert to using the inherent Mobile IP client as required.

It is inefficient concerning optimum utilization of network resources:

In many of the above-described cases, a host entity having an inherent mobile IP client may be assigned a proxy agent. This behaviour imposes unnecessary load on the network, since the network has to provide mobility management for the host entity, the management of which, however, could be performed by the host entity itself as well.

### SUMMARY

In consideration of the above, it is an object of the present invention to overcome one or more of the above drawbacks. In particular, the present invention provides a transmitter, a receiver and system as well as related methods and computer programs for identifying at least one network capability.

This invention proposes an enhancement to the deployment and use of Mobile IP which will make the operation of host entity-based and mobile IP more efficient.

According to the present invention, in a first aspect, this object is for example achieved by an apparatus comprising:

a transmitter configured to transmit an identifier for identifying at least one network capability related to mobile internet protocol,

wherein the identifier is configured to indicate capability or incapability of mobile internet protocol support.

According to advantageous further refinements of the invention as defined under the above first aspect,

the identifier is configured to indicate capability or incapability of proxy mobile internet protocol support;

the transmitter is configured to broadcast the identifier;

the transmitter is configured to advertise the at least one network capability of a routing entity;

the identifier is at least one bit;

the identifier is at least one bit comprised in a dynamic host configuration protocol response responsive to a dynamic host configuration protocol inquiry;

the identifier is at least one bit, and the at least one bit is comprised in an option field of the response.

According to the present invention, in a second aspect, this object is for example achieved by an apparatus comprising:

a receiver configured to receive an identifier for identifying at least one network capability, and;

a retriever configured to retrieve an address from the network based on the identifier.

According to advantageous further refinements of the invention as defined under the above second aspect,

the identifier is at least one bit;

the identifier is configured to indicate capability or incapability of proxy mobile internet protocol support;

the apparatus according to the first aspect further comprises a sender configured to send a dynamic host configuration protocol inquiry, wherein the receiver is configured to receive the identifier in a dynamic host configuration protocol response responsive to the dynamic host configuration protocol inquiry;

the identifier is at least one bit, and the at least one bit is comprised in an option field of the response.

According to the present invention, in a third aspect, this object is for example achieved by a system comprising:

a transmitter configured to transmit an identifier for identifying at least one network capability;

a receiver configured to receive the identifier for identifying the at least one network capability, and;

a retriever configured to retrieve an address from the network based on the identifier.

According to advantageous further refinements of the invention as defined under the above third aspect,

the identifier is configured to indicate capability or incapability of proxy mobile internet protocol support.

According to the present invention, in a fourth aspect, this object is for example achieved by a method comprising:

transmitting an identifier for identifying at least one network capability related to mobile internet protocol,

wherein the identifier is configured to indicate capability or incapability of mobile internet protocol support.

According to advantageous further refinements of the invention as defined under the above fourth aspect,

the identifier is configured to indicate capability or incapability of proxy mobile internet protocol support;

the transmitting is performed by broadcasting the identifier;

the transmitting is performed by advertising the at least one network capability of a routing entity;

the identifier is at least one bit;

the identifier is at least one bit comprised in a dynamic host configuration protocol response responsive to a dynamic host configuration protocol inquiry;

the identifier is at least one bit, and the at least one bit is comprised in an option field of the response.

According to the present invention, in a fifth aspect, this object is for example achieved by a method comprising:

receiving the identifier for identifying the at least one network capability; and

retrieving an address from the network based on the identifier.

According to advantageous further refinements of the invention as defined under the above fifth aspect,

the identifier is at least one bit;

the identifier is configured to indicate capability or incapability of proxy mobile internet protocol support;

wherein the method according to the fifth aspect further comprises sending a dynamic host configuration protocol inquiry, wherein, in the receiving, the identifier is received in a dynamic host configuration protocol response responsive to the dynamic host configuration protocol inquiry;

the identifier is at least one bit, and the at least one bit is comprised in an option field of the response.

According to the present invention, in a sixth aspect, this object is for example achieved by an apparatus comprising:

means for transmitting an identifier for identifying at least one network capability related to mobile internet protocol,

wherein the identifier is configured to indicate capability or incapability of mobile internet protocol support.

According to the present invention, in a seventh aspect, this object is for example achieved by an apparatus comprising:

means for receiving an identifier for identifying at least one network capability, and; means for retrieving an address from the network based on the identifier.

According to the present invention, in an eighth aspect, this object is for example achieved by a computer program embodied on a computer-readable medium, configured to control a method comprising:

transmitting an identifier for identifying at least one network capability related to mobile internet protocol,

wherein the identifier is configured to indicate capability or incapability of mobile internet protocol support.

According to advantageous further refinements of the invention as defined under the above eighth aspect,

the identifier is configured to indicate capability or incapability of proxy mobile internet protocol support;

the computer program is directly loadable into an internal memory of an access entity.

According to the present invention, in a ninth aspect, this object is for example achieved by a computer program embodied on a computer-readable medium, configured to control a method comprising:

receiving the identifier for identifying the at least one network capability, and; retrieving an address from the network based on the identifier.

According to advantageous further refinements of the invention as defined under the above ninth aspect,

the computer program is directly loadable into an internal memory of a host entity.

In this connection, it has to be pointed out that advantageously the present invention enables one or more of the following:

deciding whether or not the host entity is to use the network provided mobility support or to rely on the inherent Mobile IP client, if applicable.

resolving issues related to co-existence of Proxy mobile IP and host entity based mobile IP.

reliable awareness of the host entity concerning mobility management by the network and applying this information for applications relying on mobility awareness.

a host entity being aware of Proxy Mobile IP support in the network is enabled to request or indicate preferences whether to use the network provided mobility support or to having an address assigned which does not provide mobility support.

efficient utilization of network resources, since a host entity having an inherent mobile IP client is given the opportunity to decide whether to use the inherent mobile IP client in case little processing load is imposed on the host entity, or to have a proxy server assigned in case heavy processing load is imposed on the host entity, e.g. when a user launches a plurality of applications on the host entity.

Therefore, with PMIP becoming a well understood standard adopted by many different types of networks, it will be of advantage for the host entity to be aware of mobility support in the network. Network based mobility protocols such as PMIP benefit from that the host entity being aware of PMIP existence in the network.

### BRIEF DESCRIPTION OF THE DRAWINGS

Aspects of the present invention are described herein below with reference to the accompanying drawings, in which:

FIG. 1 shows a method for network capability identifying according to a first aspect of the present invention;

FIG. 2 shows a method for network capability identifying according to a second aspect of the present invention;

FIG. 3 shows a method for network capability identifying according to a third aspect of the present invention;

FIG. 4 shows an access entity and a host entity according to the first and third aspects of the present invention; and

FIG. 5 shows an access entity and a host entity according to the second aspect of the present invention

### DETAILED DESCRIPTION OF ASPECTS OF THE PRESENT INVENTION

Aspects of the present invention are described herein below by way of example with reference to the accompanying drawings.

There are several aspects (implemented e.g. on different layers) concerning implementation of the solution according to the present invention. Without being restricted thereto, three aspects are described herein below, being (1) implementation via router advertisements e.g. from an access entity; (2) implementation via DHCP messaging in both the host entities and the DHCP servers; and/or (3) implementation of indication via an air interface beacon.

Aspect 1: Router Advertisement

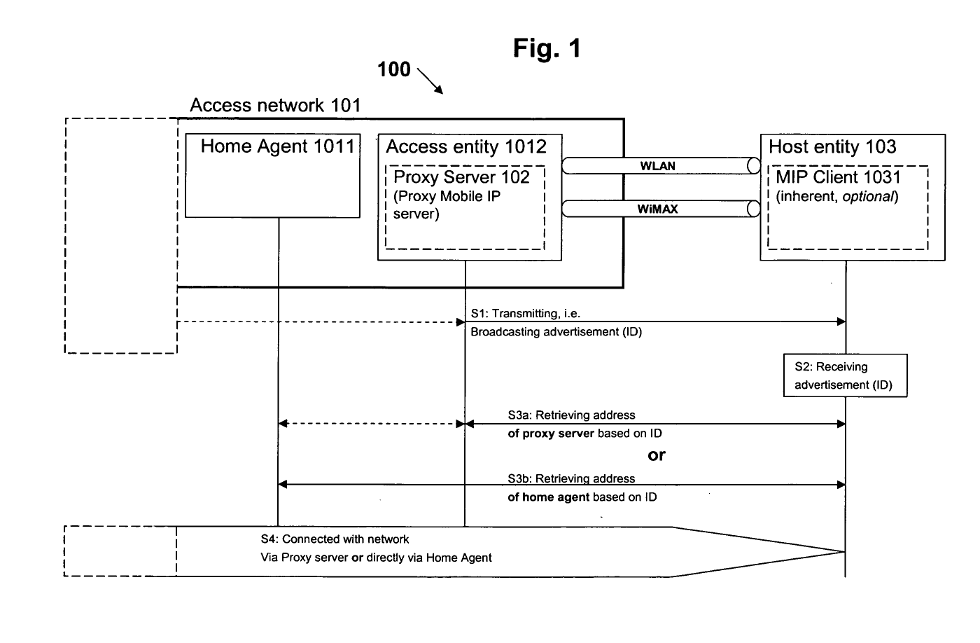

FIG. 1 shows a method for network capability identifying related to mobile IP according to a first aspect of the present invention. Signalling between elements is indicated in horizontal direction, while time aspects between signalling are reflected in the vertical arrangement of the signalling sequence as well as in the sequence numbers.

As shown in FIG. 1, a communication network 100 comprises an access network 101 comprising a home agent 1011 for providing network functionalities and an access entity 1012 for providing access-termination to a host entity 103. As indicated by the dash-dotted boxes, the access network 101 may provide access to a routing network such as e.g. the internet. The access entity 1012 may comprise a proxy server 102 (proxy mobile IP server, PMIP server hereinafter) for providing client functionalities to the host entity 103 as described hereinabove.

The host entity 103 may be any mobile or wirebound terminal capable of speech or data transceiving. As a particular example, to which the present invention is not to be restricted to, the host entity 103 may be configured to use access technologies such as WLAN (Wireless Local Area Network) or WiMAX (Worldwide Interoperability for Microwave Access). Furthermore, the host entity 103 may comprise an optional inherent MIP client 1031 for providing client functionalities to the host entity 103.

In step S1, e.g. the access entity 1012 or another entity in the access network 101 or routing network may transmit or broadcast an advertisement to the host entity 103. Alternatively, e.g. the access entity 1012 may send an unsolicited router advertisement, or the host entity 103 may send a router solicitation when IP level connectivity is detected. This advertisement may comprise an identifier (ID) for identifying at least one network capability related to MIP, e.g. PMIP.

In step S2, the advertisement comprising the ID is received by the host entity 103.

Depending on whether or not the host entity 103 comprises the inherent MIP client 1031, one of the following steps S3a and S3b is effected:

In case the host entity does not comprise the inherent MIP client 1031, the host entity 103 may be configured to use the proxy server 102 as a PMIP client. Therefore, in step S3a, the address of the proxy server 102 acting as a MIP client for the host entity 103 is retrieved.

In case the host entity does comprise the inherent MIP client 1031, the host entity 103 may be configured to use the inherent MIP client 1031 as well as to use the proxy server 102 as a PMIP client, depending e.g. on the host entity's requirement for mobility support or availability of MIP or PMIP clients, as described above. Therefore, in step S3a, the address of the proxy server 102 acting as a client for the host entity 103 is retrieved. As an alternative, in step S3b, with the address of the home agent 1011 is retrieved.

Subsequently, in step S4, the host entity 103 is in the connected state with the routing network via the home agent 1011, while being access-terminated by the access entity 1012. This connected state is substantially independent from whether the client functionality is provided by the PMIP server 102 or the inherent MIP client 1031. Furthermore, the connected state is independent from the chosen access technology (e.g. WLAN or WiMAX) as long as the host entity 103 and access entity 1012 provide at least one common of these access technologies.

The first aspect may be summarized as follows without being restricted to the following implementation details: A router advertisement can be used to indicate whether or not the access network 101 (i.e. the home agent 1011 and the access entity 1012) supports Proxy Mobile IP (PMIP). For example, this is especially advantageous in IPv6 router advertisements. At least one bit in the router advertisement may be used as a flag to indicate the support or lack of support for PMIP in the network. A host entity receiving this router advertisement either unsolicited or as a response to a router solicitation may be configured to parse the advertisement and to realize whether or not the access network 101 supports proxy mobile IP.

Aspect 2: DHCP Messaging

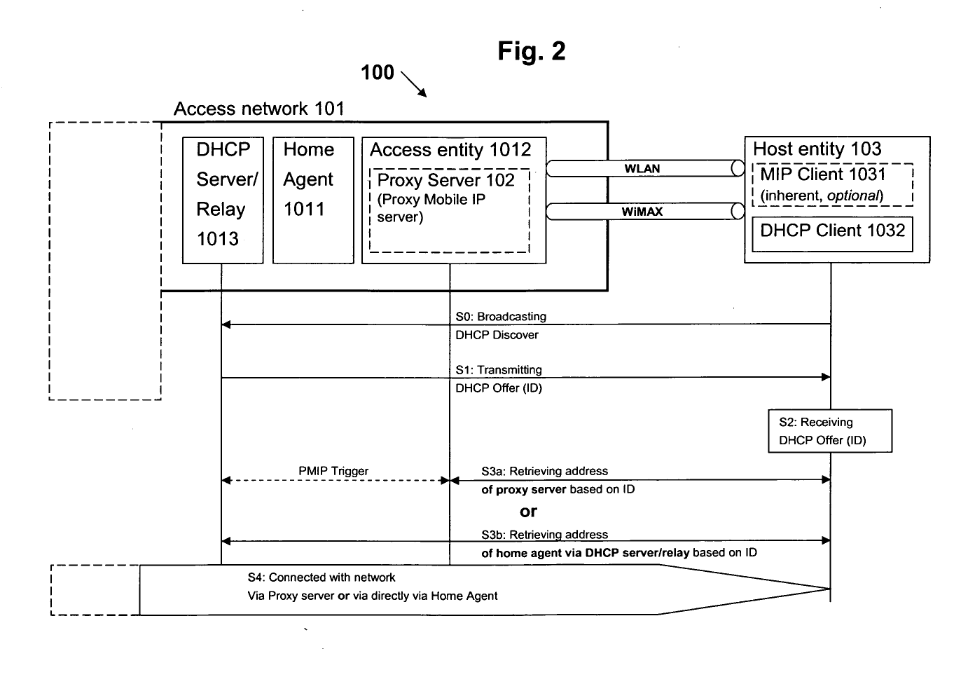

FIG. 2 shows a method for network capability identifying related to mobile IP according to a second aspect of the present invention. Again, signalling between elements is indicated in horizontal direction, while time aspects between signalling are reflected in the vertical arrangement of the signalling sequence as well as in the sequence numbers.

Referring back to FIG. 1, the same reference signs designate the same or similar components in FIG. 2. For the sake of description brevity, description of the components being unchanged as compared to FIG. 1 (i.e. communication network 100, access network 101, home agent 1011, access entity 1012, proxy server 102, host entity 103 and the optional MIP client 1031 as well as WLAN and WiMAX access technologies) is omitted. As for the differences, the access network 101 comprises a DHCP server or relay 1013 configured to provide DHCP functionalities and the host entity 103 comprises a DHCP client 1032 configured to provide DHCP functionalities.

In a preliminary step S0, the host entity 103 (i.e. the DHCP client 1032) is configured to broadcast a DHCP Discover inquiring the presence or absence of any DHCP server or relay to the access network 101, which DHCP inquiry is received e.g. by the DHCP server or relay 1013. In addition, the access entity 1012 and the DHCP server or relay 1013 may be implemented in a distributed fashion in the access network 101 or may also be implemented in a single entity (not shown).

The DHCP server or relay 1013 having received the DHCP Discover may hold or have access to information related network access (e.g. dynamic address resources for mobile host entities), and may be configured to generate a corresponding DHCP response (e.g. a DHCPOFFER message) comprising the above-described ID e.g. in the options field of the DHCP Offer.

In step S1, the generated DHCP Offer comprising the ID is transmitted to the host entity 103 e.g. from the DHCP server or relay 1013.

In step S2, the host entity 103 receives the DHCP Offer comprising the ID.

The host entity 103 may be configured to use the inherent MIP client 1031 as well as to use the proxy server 102 as a PMIP client, depending e.g. on requirements of the host entity 103 for mobility support or availability of the MIP or PMIP clients, as described above.

Therefore, in step S3a, the host entity 103 is configured to issue, to the DHCP server or relay 1013, e.g. a DHCP Request comprising an indication that the host entity 103 does not use the MIP client 1031 because the MIP client 1031 is not comprised in the host entity 103 or because the host entity 103 chooses not to use the MIP client 1031. In return, the DHCP server or relay 1013 may be configured to issue a PMIP trigger for indicating usage of the proxy server 102 as a client to the proxy server 102, and the address of the proxy server 102 acting as a client for the host entity 103 is retrieved from the DHCP server or relay 1013.

As an alternative, in step S3b, the host entity 103 is configured to issue, to the DHCP server or relay 1013, e.g. a DHCP Request comprising an indication that the host entity 103 is configured to use the MIP client 1031. In return, the DHCP client or relay 1013 may be configured to issue no PMIP trigger or a PMIP trigger for indicating non-usage of the proxy server 102 as a client to the proxy server 102, and the address of the home agent 1011 is retrieved from the DHCP server or relay 1013. In other words, the host entity 103 obtains e.g. an IP address via DHCP (or other means) and the address that is being delivered to the host entity 103 is actually the home address obtained from the home agent 1011 (or routing network).

Subsequently, in step S4, the host entity 103 is in the connected state with the routing network via the home agent 1011, while being access-terminated by the access entity 1012. Step S4 of FIG. 2 is substantially identical with step S4 of FIG. 1.

The second aspect may be summarized as follows without being restricted to the following implementation details: A host entity 103 obtains e.g. an IP address, normally via DHCP. A new DHCP option (e.g. in the option field) can be defined which would indicate support for

Proxy Mobile IP in the network. The host entity 103 would query e.g. in the DHCPDISCOVER or DHCPREQUEST message for the support for Proxy MIP in the network. The DHCPOFFER or DHCPACK messages would indicate positively or negatively about Proxy Mobile IP support in the access network 101.

Aspect 3: Indication Via Air Interface Beacon

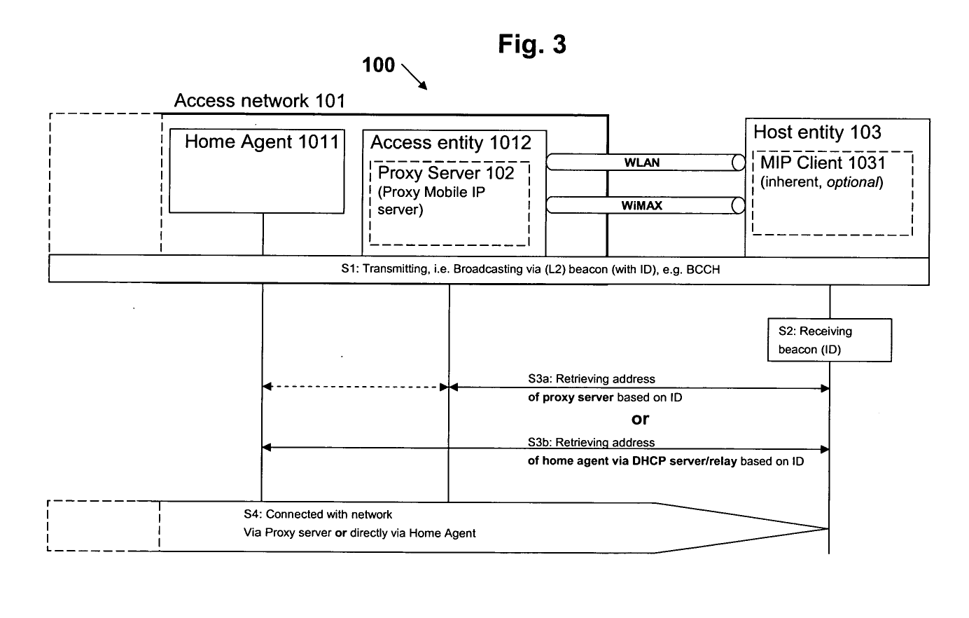

FIG. 3 shows a method for network capability identifying related to mobile IP according to a third aspect of the present invention. Again, signalling between elements is indicated in horizontal direction, while time aspects between signalling are reflected in the vertical arrangement of the signalling sequence as well as in the sequence numbers.

Referring back to FIG. 1, the same reference signs designate the same or similar components in FIG. 3. For the sake of description brevity, description of the components being unchanged as compared to FIG. 1 (i.e. communication network 100, access network 101, home agent 1011, access entity 1012, proxy server 102, host entity 103 and optional inherent MIP client 1031 as well as WLAN and WiMAX access technologies) is omitted.

In step S1, a beacon (e.g. the broadcast control channel BCCH) is transmitted or broadcasted from at least one entity in the network e.g. to the host entity 103. The beacon comprises the above-described identifier ID e.g. as a part of the system information. It is to be noted that the beacon is situated e.g. in layer 2 (data link) of the IP stack according to the OSI (Open System Interconnection) model.

This beacon is allocated for the purpose of the host entity 103 to synchronize with other network entities and to obtain various system parameters.

In step S2, the beacon comprising the ID is received by the host entity 103. It is to be noted that in case the subsequent step S3a or S3b is effected in a higher layer of the IP stack (e.g. retrieval in layer 7: application), the reception of the ID in layer 2 would have to be notified to the layers higher than layer 2 e.g. via a trigger or API (Application Programming Interface). As an example, the above notification can e.g. be implemented via handles or pointers returned by services of a given layer, when these services are called by the subsequently higher layer.

Depending on whether or not the host entity 103 comprises the inherent MIP client 1031, one of the following steps S3a and S3b is effected, as described in conjunction with steps S3a and S3b of FIG. 1.

Subsequently, in step S4, the host entity 103 is in the connected state with the routing network via the home agent 1011, while being access-terminated by the access entity 1012. Step S4 of FIG. 3 is substantially identical with step S4 of FIG. 1.

The third aspect may be summarized as follows without being restricted to the following implementation details: Depending on the air-interface technology, a bit can be added to the beacon which is an indication for support of Proxy Mobile IP in the network 100. A host entity 103 receiving the beacon information (e.g. at layer 2) would e.g. be able to understand the network capability and provide this information to the IP stack e.g. via a trigger or API.

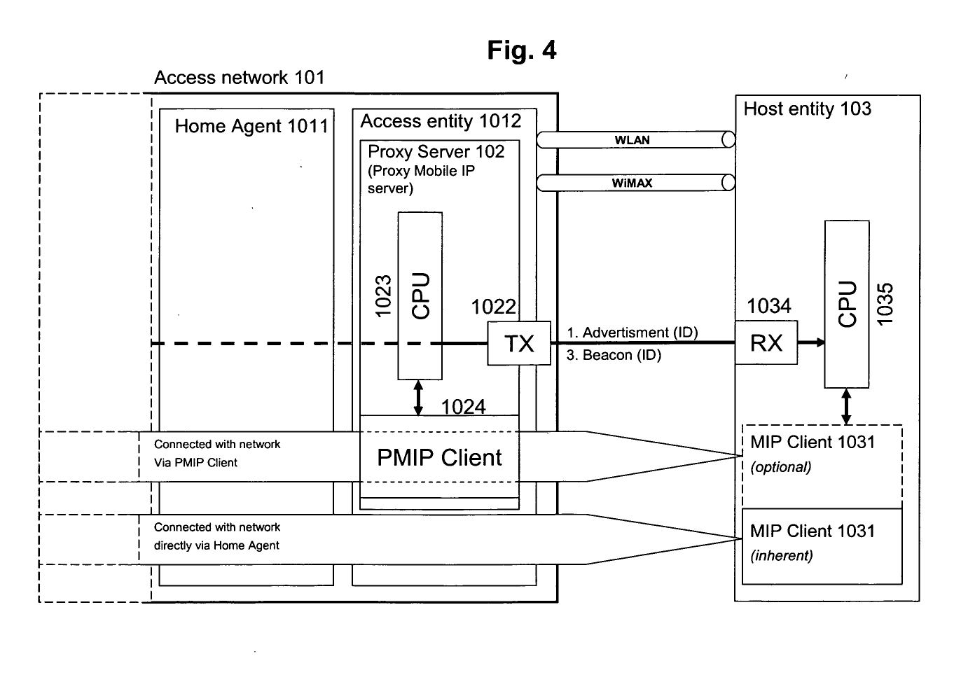

FIG. 4 shows an access entity 1012 and a host entity 103 according to the first and third aspects of the present invention.

As shown in FIG. 4, the access entity 1012 comprises a transmitter (TX) 1022, a CPU (central processing unit) 1023 configured to process various signals and a PMIP Client 1024 for providing Proxy MIP client functionality. It is to be noted that the transmitter 1022 may be a section of the proxy server 102 or may be provided as a functionality to the proxy server 102 e.g. by the access entity 1021 or the access network 101.

As further shown in FIG. 4, the host entity 103 comprises a receiver (RX) 1034, a CPU 1035 configured to process various signals and an optional MIP client 1031.

The access network 101 and the home agent 1011 are the same as described in conjunction with FIGS. 1 to 3 hereinabove.

In the embodiment shown in FIG. 4, the proxy server 102 and the related PMIP client 1024 may be comprised in the access entity 1012. However, one or both of the proxy server 1012 and the PMIP client 1024 could also be located at other appropriate locations in e.g. in the access network 101.

In other words, the PMIP client 1024 is situated e.g. in the access network. This PMIP client 1024 is an entity that generally exists e.g. in the access entity 1012 or an element such as an ASN-GW (Access Serving Network Gateway) (in WiMAX) or a PDSN (Packet Data Serving Node) (in cdma2000, code division multiple access/EV-DO, evolution data only).

It should be noted that the transmitter 1022 and the receiver 1034 of the host entity 103 may be implemented e.g. configured to transmit/receive in at least one common layer of the IP stack (e.g. layer 2 or layer 7, see above) or to transmit/receive in a multi-layer fashion.

The CPU 1023 of the proxy server 102 may in response to an event (e.g. time-triggered or the like) send the above-described ID via the transmitter 1022. The ID may be comprised in a router advertisement (see above first aspect: router advertisement), a beacon (see above third aspect: indication via air interface beacon) or any other suitable data packet or format capable of conveying the ID. The ID comprised in any of the above formats may be received by the receiver 1032 of the host entity 1033.

The CPU 1035 of the host entity 103 may be configured to initiate or to configure the optional MIP client 1031 of the host entity 103 according to the information in the ID related e.g. to support/lack of support of PMIP. It is noted that failure to receive the ID may be interpreted as lack of support by the CPU 1033. Further, the CPU 1033 of the host entity 103 may be configured to provide information from one IP stack layer to higher layer(s) as described above.

As described above in conjunction with the first to third aspects and FIGS. 1 and 3, if the inherent MIP client 1031 is not present in the host entity 103 (i.e. is a legacy host entity), the CPU 1033 of the host entity 103 may retrieve the address of the proxy server 102 (see also step S3a in FIGS. 1 to 3). In case the MIP client 1031 is present in the host entity 103, the CPU 1033 of the host entity 103 has the opportunity to choose between retrieval of the address of the proxy server 102 and retrieval of the address of the home agent 1011 directly, depending e.g. on requirements of the host entity 103 for mobility support or availability of the MIP client 1031 or the PMIP client 1024.

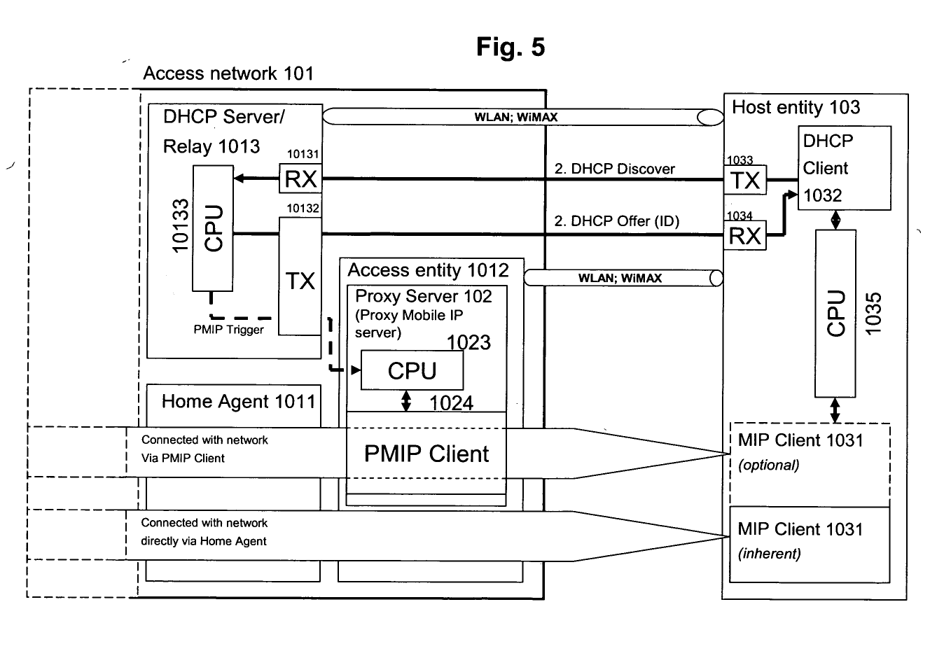

FIG. 5 shows an access entity 1012 and a host entity 103 according to the second aspect of the present invention.

Referring back to FIG. 4, the same reference signs designate the same or similar components in FIG. 5. For the sake of description brevity, description of the components being unchanged as compared to FIG. 4 (i.e. access network 101, home agent 1011, access entity 1012, proxy server 102, host entity 103, optional inherent MIP client 1031, CPUs 1023 and 1035 and PMIP client 1024 as well as WLAN and WiMAX access technologies) is omitted.

As for the differences between FIGS. 4 and 5, the host entity 103 further comprises the DHCP client 1032 (see FIG. 2) and a sender 1033. In addition, the access network 101 further comprises the DHCP server or relay 1013 (see FIG. 2) comprising a receiver 10131, a transmitter 10132 and a CPU 10133 for processing various signals.

With reference to FIG. 2, the DHCP client 1032 of the host entity 103 may broadcast a DHCP Discover via the sender 1033. The DHCP Discover is received by the receiver 10131 and relayed to the CPU 10133 of the DHCP server or relay 1013. The CPU 10133 is configured to hold or have access to the address of the home agent 1011 and, if present, to the address of the proxy server 102. The CPU 10133 may then be configured to send, via the transmitter 10132, the DHCP Offer comprising the identifier ID on whether or not the access network 101 is PMIP-capable, i.e. whether the proxy server 102 is present, to the DHCP client 1032 of the host entity 103 via the receiver 1034. During the subsequent address retrieval operation (not shown in FIG. 5, see steps 3a and 3b of FIG. 2), the CPU 10133 of the DHCP server or relay 1013 may be configured to send, via the transmitter 10132, the PMIP trigger and the address of the proxy server 102 or the address of the home agent 1011 based on the indication received from the host entity 103.

Furthermore, it is to be noted that that the sender 10131 and the receiver 10132 of the DHCP server or relay 1013 may also be implemented as a single transceiving entity (not shown). Furthermore, the transmitter 1033 and the receiver 1034 of host entity 103 may also be implemented as a single transceiving entity (Not Shown)

The DHCP server or relay 1013 and the proxy server 102 may be arranged in a distributed fashion or alternatively in a single entity (not shown). In the latter case, the DHCP server or relay 1013 and the proxy server 102 may also be configured to share a common CPU (CPUs 1023 and 10133).

Furthermore, according to the present invention, it is noted that the trigger for PMIP may not be the AAA (Authentication Authorization Accounting) profile which is inquired e.g. when the host entity 103 enters within the vicinity of the access network, but normally e.g. a DHCP request (see above second aspect).

The AAA profile may not provide information whether or not the user or subscriber should be provided with the PMIP service. The subscriber could use host entities (at different times) which are MIP client enabled (CMIP-enabled) and which sometimes do not provide the inherent MIP client 1031. Therefore, the AAA profile is in most conditions or scenarios not able to determine whether or nor PMIP should be triggered.

Furthermore, a CMIP-enabled host entity 103 could be configured to send an initial DHCP request to obtain a local address in the access network (see above second aspect). This sending operation becomes the trigger for PMIP and a proxy agent (or server) is triggered in the network. A host entity 103 having the inherent MIP client 1031 will then not be able to switch to a CMIP-enabled mode of operation as a result. Such a situation can be avoided, because with the embodiment, the host entity 103 is provided with information on whether or not PMIP is supported in the access network in advance.

In this context, if e.g. a WiMAX CMIP-enabled host entity 103 fails to register for some reason and is treated as a host entity requiring PMIP, the host entity 103 is not given the opportunity to switch to the CMIP-enabled mode. On the other hand, in a non-WiMAX case, a CMIP-enabled host entity 103 may default into co-located CoA (Care of Address) mode which may not be desirable.

However, with dual stack host entities and with the ability to have client capability such as MIP4, MIP6 or DS-MIP(4/6) (dual stack MIP), the host entity is equipped with a number of choices and options. The host entity needs to be aware whether the access network is capable of supporting Proxy MIP. The awareness of Proxy MIP in the access network is advantageous for the host entity 103, because this information enables the host entity to decide whether to trigger a DHCP (see first aspect described herein above) request, to send a MIP request or the like. Without this awareness, a client Mobile IP host entity for example would not be able to switch to CMIP if it were to send a DHCP request prior to activating the Mobile IP client. Awareness of the access networks capability to support mobility via PMIP will also enable applications in the host entity to adapt accordingly.

For the purpose of the present invention as described herein above, it should be noted that

an access technology may be any of the above-described technologies by means of which a terminal can access a communication network. Although in the foregoing only WLAN and WiMAX are used as exemplary access technologies for descriptive purposes, other present or future technologies, such as the technologies described above or BlueTooth©, Infrared, and the like may be used; although the above technologies are mostly wireless access technologies, e.g. in different radio spectra, access technology in the sense of the present invention may also imply wirebound technologies;

a host entity in turn may for example be any device, unit or means by means of which a user accesses a communication network, i.e. at least one network element thereof; this implies that a host entity as referred to in the present specification may correspond to a mobile as well as a non-mobile device, independent of the technology platform on which the host entity is based;

generally, the present invention is advantageously applicable in those network/terminal environments relying on a data packet based transmission scheme according to which data are transmitted in data packets and which are for example based on the Internet Protocol IP. The present invention is, however, not limited thereto, and any other present or future MIP version, or, more generally, a protocol following similar principles as MIPV4/6, is also applicable; furthermore, in case of MIPv4, if the host entity is CMIP-capable, the host entity may be configured to use CMIP for address configuration. In the case of MIPv6, the host entity may be configured to request a prefix from the local domain rather than the prefix from the home domain;

a network element may for example be any device, unit or means by means of which a terminal may have access to a communication network and that provides gateway functionality for enabling a terminal to experience services provided by the communication network;

an access entity as a network element or at least as a part of a network element may for example be any device, unit or means by which a user can access to a communication network based on an access technology;

a beacon may be any device, unit or means, by means of which in cellular and wireless networks, an access entity e.g. via base station is configured to broadcast certain information over a channel;

method steps likely to be implemented as software code portions and being run using a processor at the network element, are software code independent and can be specified using any known or future developed programming language as long as the functionality defined by the method steps is preserved;

generally, any method step is suitable to be implemented as software or by hardware without changing the idea of the present invention in terms of the functionality implemented;

method steps and/or devices, units or means likely to be implemented as hardware components at a terminal or network element or module thereof are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;

devices, units or means (e.g. host entity and proxy server) can be implemented as individual devices, units or means, but this does not exclude that they are implemented in a distributed fashion throughout the system, as long as the functionality of the device, unit or means is preserved.

1. An apparatus, comprising:
a transmitter configured to transmit an identifier for identifying at least one network capability related to mobile internet protocol,
wherein the identifier is configured to indicate capability or incapability of mobile internet protocol support.

2. The apparatus according to claim 1, wherein the identifier is configured to indicate capability or incapability of proxy mobile internet protocol support.

3. The apparatus according to claim 1, wherein the transmitter is configured to broadcast the identifier.

4. The apparatus according to claim 1, wherein the transmitter is configured to advertise the at least one network capability of a routing entity.

5. The apparatus according to claim 1, wherein the identifier is at least one bit.

6. The apparatus according to claim 1, wherein the identifier is at least one bit comprised in a dynamic host configuration protocol response responsive to a dynamic host configuration protocol inquiry.

7. The apparatus according to claim 6, wherein the identifier is at least one bit, and the at least one bit is comprised in an option field of the response.

8. An apparatus, comprising:
a receiver configured to receive an identifier for identifying at least one network capability, and;
a retriever configured to retrieve an address from the network based on the identifier.

9. The apparatus according to claim 8, wherein the identifier is at least one bit.

10. The apparatus according to claim 8, wherein the identifier is configured to indicate capability or incapability of proxy mobile internet protocol support.

11. The apparatus according to claim 8, further comprising:
a sender configured to send a dynamic host configuration protocol inquiry, and wherein
the receiver is configured to receive the identifier in a dynamic host configuration protocol response responsive to the dynamic host configuration protocol inquiry.

12. The apparatus according to claim 11, wherein the identifier is at least one bit, and the at least one bit is comprised in an option field of the response.

13. A system, comprising:
a transmitter configured to transmit an identifier for identifying at least one network capability;
a receiver configured to receive the identifier for identifying the at least one network capability, and;
a retriever configured to retrieve an address from the network based on the identifier.

14. The system according to claim 13, wherein the identifier is configured to indicate capability or incapability of proxy mobile internet protocol support.

15. A method, comprising:
transmitting an identifier for identifying at least one network capability related to mobile internet protocol,
wherein the identifier is configured to indicate capability or incapability of mobile internet protocol support.

16. The method according to claim 15, wherein the identifier is configured to indicate capability or incapability of proxy mobile internet protocol support.

17. The method according to claim 15, wherein the transmitting is performed by broadcasting the identifier.

18. The method according to claim 15, wherein the transmitting is performed by advertising the at least one network capability of a routing entity.

19. The method according to claim 15, wherein the identifier is at least one bit.

20. The method according to claim 15, wherein the identifier is at least one bit comprised in a dynamic host configuration protocol response responsive to a dynamic host configuration protocol inquiry.

21. The method according to claim 20, wherein the identifier is at least one bit, and the at least one bit is comprised in an option field of the response.

22. A method, comprising:
receiving the identifier for identifying the at least one network capability; and
retrieving an address from the network based on the identifier.

23. The method according to claim 22, wherein the identifier is at least one bit.

24. The method according to claim 22, wherein the identifier is configured to indicate capability or incapability of proxy mobile internet protocol support.

25. The method according to claim 22, further comprising:
sending a dynamic host configuration protocol inquiry, and wherein,
in the receiving, the identifier is received in a dynamic host configuration protocol response responsive to the dynamic host configuration protocol inquiry.

26. The method according to claim 25, wherein the identifier is at least one bit, and the at least one bit is comprised in an option field of the response.

27. An apparatus, comprising:
means for transmitting an identifier for identifying at least one network capability related to mobile internet protocol,
wherein the identifier is configured to indicate capability or incapability of mobile internet protocol support.

28. An apparatus, comprising:
means for receiving an identifier for identifying at least one network capability, and;
means for retrieving an address from the network based on the identifier.

29. A computer program embodied on a computer-readable medium, configured to control a method comprising:
transmitting an identifier for identifying at least one network capability related to mobile internet protocol,
wherein the identifier is configured to indicate capability or incapability of mobile internet protocol support.

30. The computer program according to claim 29, wherein the identifier is configured to indicate capability or incapability of proxy mobile internet protocol support.

31. The computer program according to claim 29, wherein the computer program is directly loadable into an internal memory of an access entity.

32. A computer program embodied on a computer-readable medium, configured to control a method comprising:
receiving the identifier for identifying the at least one network capability, and;
retrieving an address from the network based on the identifier.

33. The computer program according to claim 32, wherein the computer program is directly loadable into an internal memory of a host entity.
